(19) United States
(12) Patent Application Publication
(10) Pub. No.: US 2006/0268019 A1
(43) Pub. Date: Nov. 30, 2006

(54) Apparatus for image scrolling detection and method of the same

(75) Inventors: Jiunn Shyang Wang, Shindian City (TW); Andy Chiu, Shindian City (TW); Sheng Che Tsao, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/195,680

(22) Filed: Aug. 3, 2005

(30) Foreign Application Priority Data
May 25, 2005 (TW) 094117124

(51) Int. Cl. G09G 5/00

(52) U.S. Cl. 345/684

(57) ABSTRACT

A method for detecting image scrolling includes the steps of catching a start address (SA) of a visible field; generating a first characteristic signal according to the SA; storing a first characteristic value of the first characteristic signal; generating a second characteristic signal according to the SA caught after the visible field moves; and generating a decision signal, which identifies a scrolling direction of an image according to the first characteristic signal and the second characteristic signal.

### BACKGROUND OF THE INVENTION

1. Field of Invention

The invention relates to an image processing apparatus and an image processing method, and more particularly to an apparatus capable of detecting a scrolling direction of an image and a method of the same.

2. Related Art

On a computer or a television screen, a frame often scrolls, for example, up and down. In order to achieve the frame scrolling effect, a field corresponding to a display range of the screen moves instead of moving the displayed image picture, such that the observer can feel that the picture is scrolling.

FIG. 1 is a schematic illustration showing a conventional method of implementing a frame scrolling effect. In FIG. 1, the observer can view the screen range corresponding to a visible field 10, and moving the visible field 10 can make the observer feel that a picture image 12 is scrolling. As shown in the portions from (a) to (c) in FIG. 1, the visible field 10 moves down, and the observer feels that the frame is scrolling up. On the contrary, as shown in the portions from (c) to (a) of FIG. 1, the visible field 10 moves up, and the observer feels that the frame is scrolling down.

Consequently, the conventional frame scrolling effect is achieved by moving the visible field, and the observer observes the flame is scrolling in a direction opposite to the moving direction of the visible field. The program designer may sometimes need to detect the image scrolling direction for the purpose of other image processing steps, such as an image scaling step.

### SUMMARY OF THE INVENTION

In view of the foregoing, the invention is to provide an image processing apparatus and an image processing method of extracting a characteristic value of a scrolling image and detecting a scrolling direction of an image.

To achieve the above, an image scrolling detection apparatus of the invention includes an extracting module and a decision module. In the invention, the extracting module is used for catching a start address (SA) of a visible field and generating a first characteristic signal according to the start address. The decision module is used for receiving a plurality of continuous characteristic signals and generating a decision signal according to the characteristic signals. The decision signal identifies a scrolling direction of an image.

In addition, the invention also discloses a method for detecting image scrolling, which includes the following steps of: catching a start address (SA) of a visible field; generating a first characteristic signal according to the SA; storing a first characteristic value of the first characteristic signal; generating a second characteristic signal according to the SA caught after the visible field moves; generating a decision signal according to the first characteristic signal and the second characteristic signal; storing a second characteristic value of the second characteristic signal to replace the first characteristic value of the first characteristic signal; and waiting for the visible field to move.

As mentioned above, the apparatus and method of detecting a scrolling detection of an image according to the invention generate a characteristic signal according to a start position of a visible field, store a plurality of characteristic signals after the visible field moves so as to generate a characteristic difference and a characteristic difference absolute value, and generate a decision signal according to the characteristic difference and the characteristic difference absolute value. As a result, the decision signal is capable of identifying a scrolling direction of the image

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional method of implementing a frame scrolling effect;

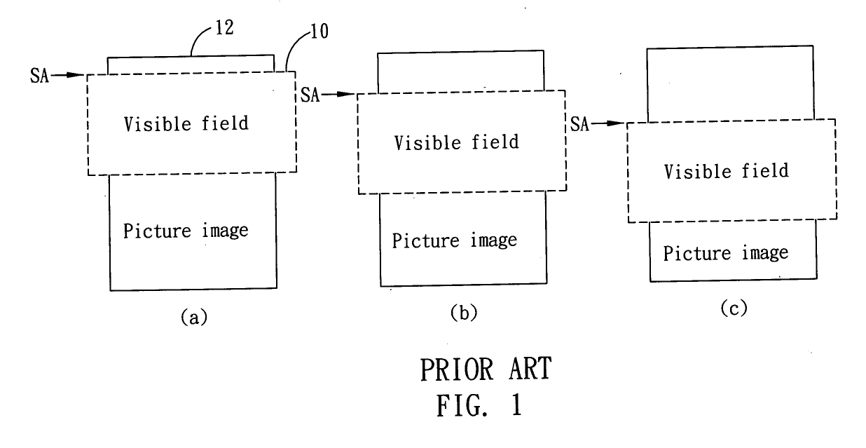

FIG. 2 is a block diagram showing an image scrolling detection apparatus according to a preferred embodiment of the invention;

FIG. 3 is a schematic illustration showing an embodiment of detecting an up-scrolling image;

FIG. 4 is a schematic illustration showing another embodiment of detecting the up-scrolling image;

FIG. 5 is a flow chart showing a method of detecting a scrolling direction of an image according to a preferred embodiment of the invention; and

FIG. 6 is a flow chart showing detailed contents of the step S98 of FIG. 5.

### DETAILED DESCRIPTION OF THE INVENTION

The present invention will be apparent from the following detailed description, which proceeds with reference to the accompanying drawings, wherein the same references relate to the same elements. The invention discloses an image processing apparatus and an image processing method of extracting a characteristic value of a scrolling image and detecting a scrolling direction of an image.

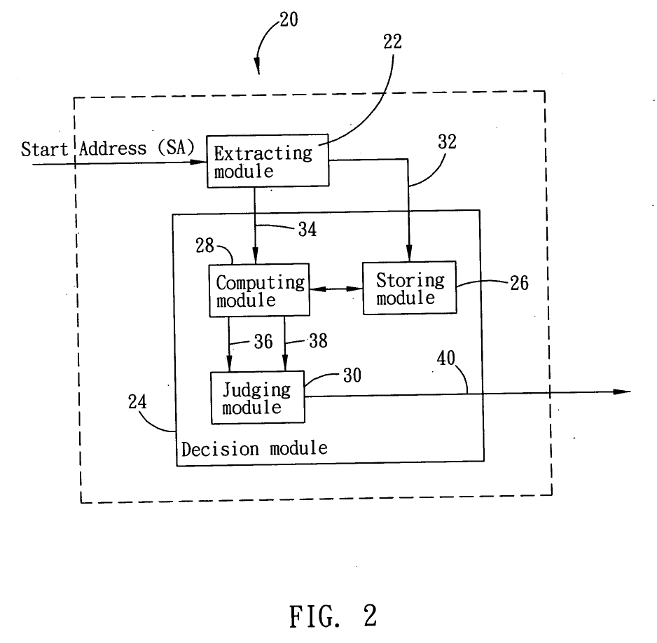

FIG. 2 is a block diagram showing an image scrolling detection apparatus 20 according to a preferred embodiment of the invention. The image scrolling detection apparatus 20 includes an extracting module 22. and a decision module 24. The decision module 24 includes a storing module 26 connected to the extracting module 22, a computing module 28 connected to the extracting module 22 and the storing module 26, and a judging module 30 connected to the computing module 28.

The extracting module 22 catches a start address (SA) of a visible field and generates a first characteristic signal 32 by corresponding the start address to a line number according to the start address. The storing module 26 receives the first characteristic signal 32 and stores a first characteristic value therein. After the visible field moves, the extracting module 22 catches the SA of the visible field again, and generates a second characteristic signal 34 in the same manner. The computing module 28 receives the second characteristic signal 34 to obtain a second characteristic value, generates a characteristic difference 36 by subtracting the first characteristic value from the second characteristic value based on the first characteristic value in the storing module 26, and further takes an absolute value of the characteristic difference 36 to generate a characteristic difference absolute value 38. After generating the characteristic difference 36 and the characteristic difference absolute value 38, the computing module 28 stores the second characteristic value back to the storing module 26 as a reference in the next computation.

When the visible field moves later, the extracting module 22 catches the SA of the visible field again, and generates a third characteristic signal in the same manner. The computing module 28 receives the third characteristic signal to obtain a third characteristic value, generates a characteristic difference- by subtracting the second characteristic value from the third characteristic value based on the second characteristic value in the storing module 26, and further takes an absolute value of the characteristic difference to generate a characteristic difference absolute value. After generating the characteristic difference and the characteristic difference absolute value, the computing module 28 stores the third characteristic value back to the storing module 26 as a reference in the next computation.

The above-mentioned operation of generating the characteristic difference and the characteristic difference absolute value is a one-cycle operation, which is triggered as long as the visible field moves. In addition, the characteristic value after the current movement is compared with that at the previous movement, such that the moving direction of the visible field is ensured, and the scrolling direction of the frame is obtained.

On the other hand, the judging module 30 receives the characteristic difference 36 and the characteristic difference absolute value 38, and generates a decision signal 40 according to the characteristic difference 36 and the characteristic difference absolute value 38. When the characteristic difference 36 is greater than zero, the characteristic difference absolute value 38 is smaller than a characteristic offset, and the characteristic difference absolute value 38 is smaller than a previously visible height, an up-scrolling decision signal is generated. When the characteristic difference 36 is smaller than zero, the characteristic difference absolute value 38 is smaller than the characteristic offset, and the characteristic difference absolute value 38 is smaller than a currently visible height, a down-scrolling decision signal is generated.

The apparatus of the invention for detecting the scrolling direction of the image generates the first characteristic signal 32 by corresponding the SA of the visible field 10 to the line number, generates the second characteristic signal 34 again in the same manner after the visible field 10 moves, and further generates the characteristic difference and the characteristic difference absolute value according to the first characteristic value and the second characteristic value. Then, the judging module 30 receives the characteristic difference and the characteristic difference absolute value, judges the scrolling direction of the image, and outputs the decision signal 40.

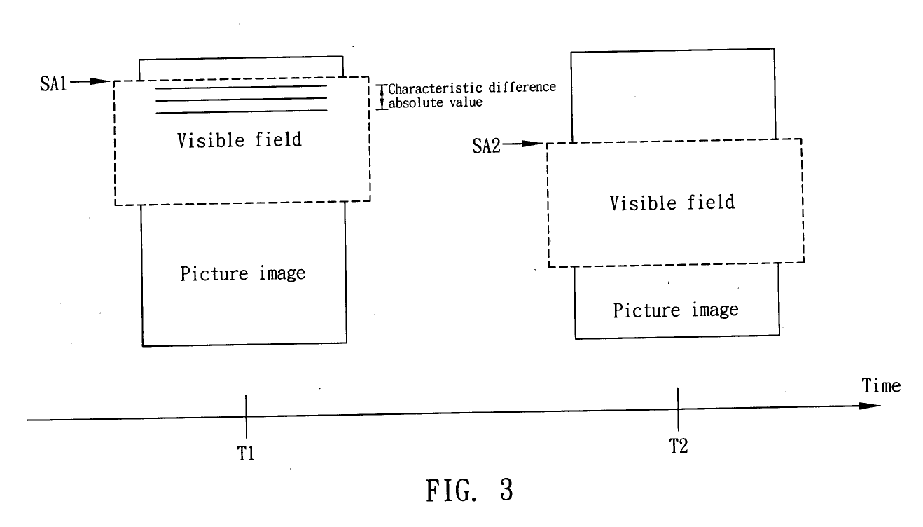

FIG. 3 is a schematic illustration showing an embodiment of detecting an up-scrolling image. Please refer to FIGS. 3 and 2 simultaneously. In FIG. 3, the horizontal axis represents the time, and the visible field moves from the state at time T1 to the state at time T2. At time T1, the extracting module 22 catches a start address SA1 of the visible field, and generates the first characteristic signal 32 by corresponding the start address SA1 to a line number according to the start address. Next, the storing module 26 stores the first characteristic value therein. At time T2, the visible field moves to a start address SA2, and the extracting module 22 catches the start address SA2 of the visible field again and generates the second characteristic signal 34 in the same manner. The computing module 28 receives the second characteristic signal 34 to obtain the second characteristic value, generates the characteristic difference 36 by subtracting the first characteristic value from the second characteristic value based on the first characteristic value in the storing module 26, and further generates the characteristic difference absolute value 38 by taking an absolute value of the characteristic difference 36. At this time, the judging module 30 receives the characteristic difference 36 and the characteristic difference absolute value 38, and generates the decision signal 40 according to the characteristic difference 36 and the characteristic difference absolute value 38. Because this is an embodiment of an up-scrolling image, the characteristic difference 36 is greater than zero, the characteristic difference absolute value 38 is smaller than the characteristic offset, and the characteristic difference absolute value 38 is smaller than a previously visible height. Finally, an up-scrolling decision signal is generated. As shown in this embodiment, if the scrolling direction is to be roughly judged, only the first condition (i.e., the characteristic difference 36 is greater than zero) can be used to judge that the image scrolls up. However, the characteristic offset is the parameter configured by the program designer to prevent the program from misjudging the visible field to be scrolled up due to the visible field moves too many lines at a time. Of course, this is a more precise program design and does not influence the technological features of the invention. As shown in the embodiment of FIG. 3, the program designer may set the characteristic offset as 4 lines, and the characteristic difference absolute value after the visible field moves is 3 lines smaller than the characteristic offset of 4 lines, such that the judging module 30 can still judge the up-scrolling in a permissible condition, which may be set according to the characteristic offset. If the program designer sets the characteristic offset as 2 lines, the judging module 30 cannot generate the decision signal because the condition that the characteristic difference absolute value is smaller than the characteristic offset cannot be satisfied.

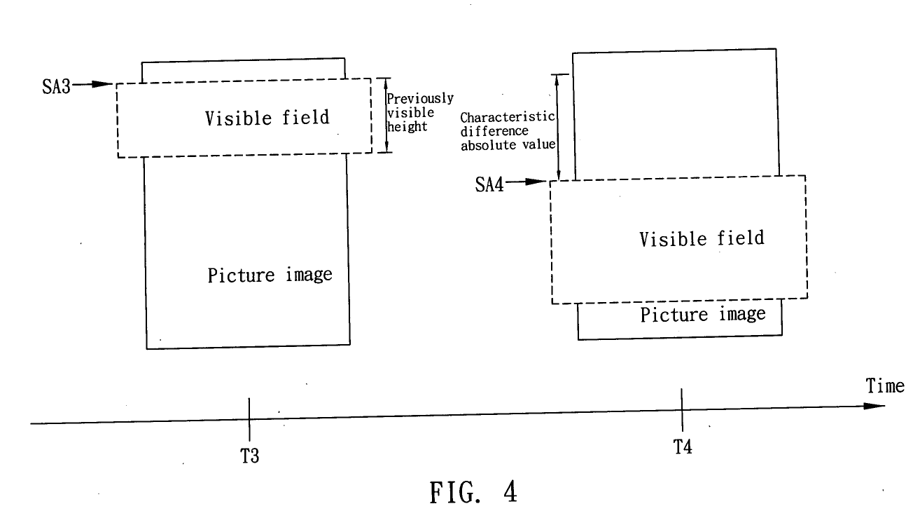

In addition, another precise condition is that the characteristic difference absolute value 38 is smaller than a previously visible height. This condition is set in order to prevent another situation from occurring. FIG. 4 is a schematic illustration showing another embodiment of detecting the up-scrolling image. As shown in FIG. 4, it is obvious that the visible field at time T3 is smaller than that at time T4. After the visible field changes from the state at time T3 to the state at time T4, the visible field moves down and the height thereof is also changed. If a rough judgment is made only according to the first condition, the image is judged to scroll up if the characteristic difference 36 is greater than zero. The precise program designer, however, considers such a condition when the heights of the previous and next visible fields are not the same. Thus, the condition that the characteristic difference absolute value 38 is smaller than the previously visible height is needed to restrict the generation of the decision signal when the move of the visible field is so great that the frames become discontinuous. Of course, this is a more precise program design, and does not influence the technological features of the invention.

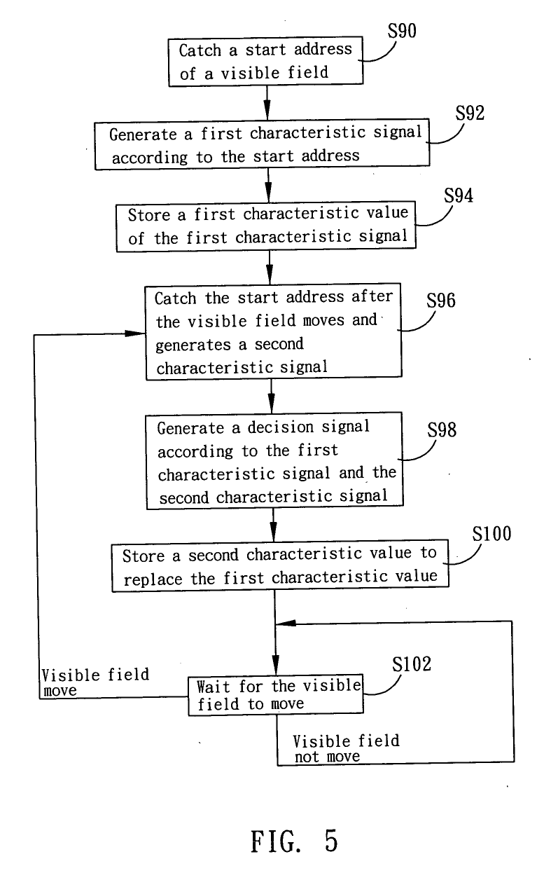

FIG. 5 is a flow chart showing a method of detecting a scrolling direction of an image according to a preferred embodiment of the invention. Referring to FIG. 5, the method of the invention includes the following steps.

Step S90 catches a start address of a visible field.

Step S92 generates a first characteristic signal according to the start address.

Step S94 stores a first characteristic value of the first characteristic signal.

Step S96 catches the start address after the visible field moves and generates a second characteristic signal.

Step S98 generates a decision signal according to the first characteristic signal and the second characteristic signal.

Step S100 stores a second characteristic value to replace the first characteristic value.

Step S102 waits for the visible field to move.

Herein, the step S102 is a waiting state. If the visible field moves, the step 96 is performed; otherwise, if the visible field does not move, the procedure holds at the step 102.

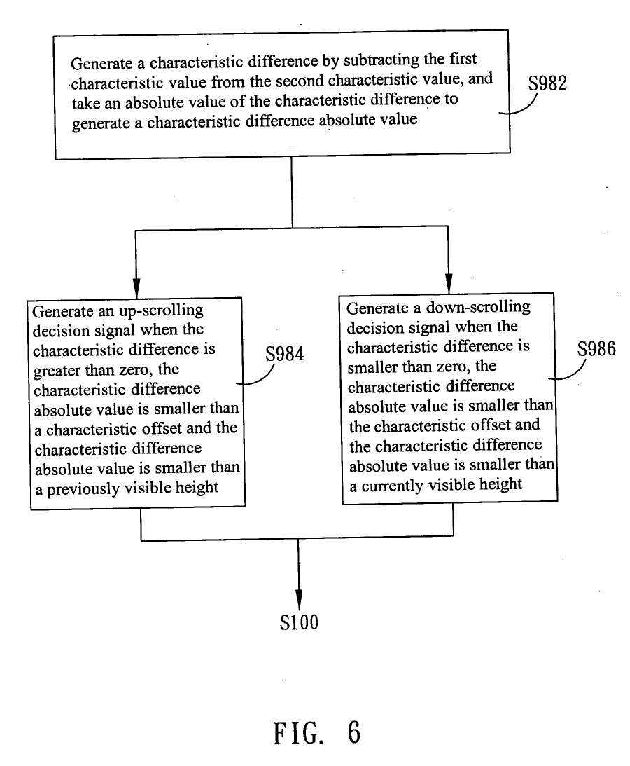

FIG. 6 is a flow chart showing detailed contents of the step S98 of FIG. 5. The step S98 includes the following detailed steps.

Step S982 generates a characteristic difference by subtracting the first characteristic value from the second characteristic value, and takes an absolute value of the characteristic difference to generate a characteristic difference absolute value.

Step S984 generates an up-scrolling decision signal when the characteristic difference is greater than zero, the characteristic difference absolute value is smaller than a characteristic offset and the characteristic difference absolute value is smaller than a previously visible height.

Step S986 generates a down-scrolling decision signal when the characteristic difference is smaller than zero, the characteristic difference absolute value is smaller than the characteristic offset and the characteristic difference absolute value is smaller than a currently visible height.

Differing from the prior art technology of implementing the frame scrolling effect, the invention converts the start address of the visible field into the characteristic value and judges the scrolling direction of the frame according to the characteristic value. These are two technological features of the invention.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An image scrolling detection apparatus for detection a scrolling direction of an image, comprising:
an extracting module, which catches a start address of a visible field, and generates a first characteristic signal according to the start address; and
a decision module, which is connected to the extracting module, receives the characteristic signal generated by the extracting module, and generates a decision signal identifying the scrolling direction of the image according to the received characteristic signal.

2. The apparatus according to claim 1, wherein the extracting module further catches the start address of the visible field after the visible field moves and generates a second characteristic signal, and the second characteristic signal is generated after the first characteristic signal is generated.

3. The apparatus according to claim 2, wherein the decision module comprises:
a storing module, which is connected to the extracting module and stores a first characteristic value of the first characteristic signal;
a computing module, which is connected to the extracting module and the storing module, receives the second characteristic signal, and computes a characteristic difference and a characteristic difference absolute value based on a content stored in the storing module; and
a judging module, which is connected to the computing module, receives the characteristic difference and the characteristic difference absolute value, and generates the decision signal according to the characteristic difference and the characteristic difference absolute value.

4. The apparatus according to claim 3, wherein the characteristic difference is obtained by subtracting the first characteristic value from a second characteristic value of the second characteristic signal.

5. The apparatus according to claim 3, wherein the characteristic difference absolute value is obtained by taking an absolute value of a subtracted result obtained by subtracting the first characteristic value from a second characteristic value of the second characteristic signal.

6. The apparatus according to claim 3, wherein the judging module generates the decision signal according to the rules of:
generating an up-scrolling decision signal when the characteristic difference is greater than zero, the characteristic difference absolute value is smaller than a characteristic offset, and the characteristic difference absolute value is smaller than a previously visible height; and
generating a down-scrolling decision signal when the characteristic difference is smaller than zero, the characteristic difference absolute value is smaller than the characteristic offset, and the characteristic difference absolute value is smaller than a currently visible height.

7. The apparatus according to claim 6, wherein the characteristic offset represents a system default offset, the previously visible height represents a height of the visible field before scrolling, and the currently visible height represents a height of the visible field after scrolling.

8. The apparatus according to claim 6, wherein the up-scrolling decision signal represents that the image seen by a user is scrolling up, and the down-scrolling decision signal represents that the image seen by the user is scrolling down.

9. An image scrolling detection method for extracting a characteristic value of a scrolling image and detecting a scrolling direction of the image, the method comprising the steps of:
(a) catching a start address of a visible field;
(b) generating a first characteristic signal according to the start address;
(c) storing a first characteristic value of the first characteristic signal;
(d) catching the start address after the visible field moves and generating a second characteristic signal;
(e) generating a decision signal according to the first characteristic signal and the second characteristic signal;
(f) storing a second characteristic value of the second characteristic signal to replace the first characteristic value of the first characteristic signal; and
(g) waiting for the visible field to move.

10. The method according to claim 9, wherein the second characteristic signal is generated after the first characteristic signal is generated.

11. The method according to claim 9, wherein the step (e) comprises:
(e1) generating a characteristic difference and a characteristic difference absolute value according to the first characteristic signal and the second characteristic signal; and
(e2) generating the decision signal according to the characteristic difference and the characteristic difference absolute value.

12. The method according to claim 11, wherein the step (e1) generates the characteristic difference by subtracting the first characteristic value from the second characteristic value, and generates the characteristic difference absolute value by taking an absolute value of a subtracted result obtained by subtracting the first characteristic value from the second characteristic value.

13. The method according to claim 11, wherein the step (e2) generates the decision signal according to the rules of:
generating an up-scrolling decision signal when the characteristic difference is greater than zero, the characteristic difference absolute value is smaller than a characteristic offset, and the characteristic difference absolute value is smaller than a previously visible height; and
generating a down-scrolling decision signal when the characteristic difference is smaller than zero, the characteristic difference absolute value is smaller than the characteristic offset, and the characteristic difference absolute value is smaller than a currently visible height.

14. The method according to claim 13, wherein the characteristic offset represents a system default offset, the previously visible height represents a height of the visible field before scrolling, and the currently visible height represents a height of the visible field after scrolling.

15. The method according to claim 13, wherein the up-scrolling decision signal represents that the image seen by a user is scrolling up, and the down-scrolling decision signal represents that the image seen by the user is scrolling down.

16. The method according to claim 9, wherein the step (g) comprises
(g1) repeating steps (d) to (g) if the visible field moves; and
(g2) executing the step (g) if the visible field does not move.
